(19) United States
(12) Patent Application Publication
(10) Pub. No.: US 2005/0195198 A1
(43) Pub. Date: Sep. 8, 2005

(54) Graphics pipeline and method having early depth detection

(76) Inventors: Michael Hugh Anderson, Levcadia, CA (US); Ann Chris Irvine, Bonsall, CA (US); Nidish Ramachandra Kamath, Placentia, CA (US); Chun Yu, San Diego, CA (US); Dan Minglun Chuang, San Diego, CA (US); Yushi Tian, San Diego, CA (US); Yingyong Qi, San Diego, CA (US)

Correspondence Address: Qualcomm Incorporated;Patents Department, 5775 Morehouse Drive, San Diego, CA, 92121-1714, US

(21) Appl. No.: 10/949,012

(22) Filed: Sep. 23, 2004

Related U.S. Application Data
(60) Provisional application No. 60/550,018, filed on Mar. 3, 2004.
(60) Provisional application No. 60/550,024, filed on Mar. 3, 2004.

(51) Int. Cl. G06T 1/20; G06T 15/40

(52) U.S. Cl. 345/506

(57) ABSTRACT

A graphics pipeline includes a plurality of sequentially arranged processing stages which render display pixel data from input primitive object data. The processing stages include at least a texturing stage and a depth test stage, and the depth test stage may be located earlier in the graphics pipeline than the texturing stage.

### CROSS-REFERENCE TO RELATED APPLICATION(S)

A claim of priority is made to U.S. provisional application Ser. No. 60/550,018, filed Mar. 3, 2004, and to U.S. provisional application Ser. No. 60/550,024, filed Mar. 3, 2004, the entire contents of which are incorporated herein by reference.

### BACKGROUND OF THE INVENTION

1. Field of the Invention

The present invention generally relates to graphics processors, and more particularly, the present invention relates to a 3D graphics pipeline in which a depth test stage is placed early in the pipeline to minimize bandwidth and/or power consumption.

2. Description of the Related Art

Graphics engines have been utilized to display three-dimensional (3D) images on fixed display devices, such as computer and television screens. These engines are typically contained in desk top systems powered by conventional AC power outlets, and thus are not significantly constrained by power-consumption limitations. A recent trend, however, is to incorporate 3D graphics engines into battery powered hand-held devices. Examples of such devices include mobile phones and personal data assistants (PDAs). Unfortunately, however, conventional graphics engines consume large quantities of power and are thus not well-suited to these low-power operating environments.

FIG. 1 is a schematic block diagram of a basic Open GL rasterization pipeline contained in a conventional 3D graphics engine. As shown, the pipeline of this example includes a triangle setup stage 101, a pixel shading stage 102, a texture mapping stage 103, a texture blending stage 104, a scissor test stage 105, an alpha test stage 106, a stencil test stage 107, a depth test stage 108, an alpha blending stage 109, and a logical operations stage 110.

In 3D graphic systems, each object to be displayed is typically divided into surface triangles defined by vertex information, although other primitive shapes can be utilized. Also typically, the graphics pipeline is designed to process sequential batches of triangles of an object or image. The triangles of any given batch may visually overlap one another within a given scene.

Referring to FIG. 1, the triangle setup stage 101 “sets up” each batch of triangles by computing coefficients to be used in computations executed by later pipeline stages.

The pixel shading stage 102 uses the vertex information to compute which pixels are encompassed by each triangle among a processed batch of triangles. Since the triangles may overlap one another, multiple pixels of differing depths may be located at the same point on a screen display. In particular, the pixel shading stage 101 interpolates the shading (lighting value), color and depth values for each pixel using the vertex information. Any of a variety of shading techniques can be adopted for this purpose, and shading operations can take place on per triangle, per vertex or per pixel bases.

The texture mapping stage 103 and texture blending stage 104 function to add and blend texture into each pixel of the process batch of triangles. Very generally, this is done by mapping pre-defined textures onto the pixels according to the vertex information. As with shading, a variety of techniques may be adopted to achieve texturing. Also, a technique known as fog processing may be implemented as well.

The scissor test stage 105 functions to discard pixels contained in portions (fragments) of triangles which fall outside the field of view of the displayed scene. Generally, this is done by determining whether pixels lie within a so-called scissor rectangle.

The alpha test unit 106 conditionally discards a fragment of a triangle (more precisely, pixels contained in the fragment) based on a comparison between an alpha value (transparency value) associated with the fragment and a reference alpha value. Similarly, the stencil test conditionally discards fragments based on a comparison between each fragments and a stored stencil value.

The depth test stage 108 (also called Hidden Surface Removal (HRS)) discards pixels contained in triangle fragments based on a depth value of the pixels and a depth value of other pixels having the same display location. Generally, this is done by comparing using a z-axis value (depth value) of a pixel undergoing the depth test with a z-axis value stored in a corresponding location of a so-called z-buffer or depth buffer. The tested pixel is discarded if the z-axis value thereof indicates that the pixel would be blocked from view by another pixel having the z-axis value stored in the z-buffer. On the other hand, the z-buffer value is overwritten with the z-axis value of the tested pixel in the case where the tested pixel would not be blocked from view. In this manner, underlying pixels which are blocked from view are discarded in favor of overlying pixels.

The alpha blending stage 109 combines rendered pixels with pixels previously stored in a color buffer based on alpha values to achieve transparency of an object.

The logical operations unit 110 generically denotes miscellaneous remaining processes of the pipeline for ultimately obtaining pixel display data.

In any graphics system, it is desired to conserve processor and memory bandwidth to the extent possible while maintaining satisfactory performance. This is especially true in the case of portable or hand-held devices where bandwidths may be limited. Also, as suggested previously, there is a particular demand in the industry to minimize power consumption when processing 3D graphics for display on portable or hand-held devices.

### SUMMARY OF THE INVENTION

According to one aspect of the present invention, a graphics pipeline is provided for processing pixel data and includes a plurality of sequentially arranged processing stages which render display pixel data from input primitive object data, where the processing stages include at least a texturing stage and a depth test stage, and wherein the depth test stage is located earlier in the graphics pipeline than the texturing stage.

According to another aspect of the present invention, a graphics pipeline is provided for processing pixel data, and includes a plurality of sequentially arranged processing stages which render display data from input primitive object data. The processing stages include at least a texturing stage, an alpha test stage and a depth test stage. Further, the pipeline is dynamically reordered between at least first and second stage sequences according to an alpha test state of processed pixel data. In the first stage sequence, the depth test stage is functionally located earlier in the graphics pipeline than the texturing stage. In the second stage sequence, the depth test stage is functionally located after the texturing stage and the alpha test stage.

According to still another aspect of the present invention, graphics pipeline for processing pixel data, and includes a depth buffer which stores depth values, and a depth test stage which compares a current depth value of a processed pixel with a previous depth value stored in the depth buffer, and which issues a write command to overwrite the previous depth value with the current depth value based on a comparison result. The graphics processor further includes write defer circuitry which temporarily defers the write command issued by depth test stage, a texturing stage which receives the processed pixel after processing by the depth test stage, and an alpha test stage which receives the processed pixel after processing by the texturing stage. The write defer circuitry is responsive to the alpha test stage to either ignore or execute the deferred write command issued by the depth test stage.

### BRIEF DESCRIPTION OF THE DRAWINGS

The above and other aspects of the invention will become readily apparent from the detailed description that follows, with reference to the accompanying drawings, in which:

FIG. 1 is a schematic block diagram of an example of a basic Open GL rasterization pipeline contained in a 3D graphics engine;

FIG. 2 is a schematic block diagram of a 3D graphics pipeline according to an example of a first embodiment of the present invention;

FIG. 3 is a schematic block diagram of a 3D graphics pipeline according to an example of a second embodiment of the present invention;

FIG. 4 is a schematic block diagram of a 3D graphics pipeline according to an example of a third embodiment of the present invention; and

FIG. 5 is a schematic block diagram of a 3D graphics pipeline according to an example of a fourth embodiment of the present invention.

### DETAILED DESCRIPTION OF PREFERRED EMBODIMENTS

The present invention is at least partially characterized by placing the depth test stage early in the graphics pipeline to minimize power and bandwidth consumption of later pipeline stages. The depth test functions to discard pixels which would not be visible because they are hidden from view by overlying pixels. Thus, by moving the depth test to an early position in the pipeline, hidden pixels are discarded in advance of processing by later high bandwidth and high power-consuming pipeline stages. As such, pipeline resources are not expended on the discarded pixels.

The present invention is also at least partially characterized by optionally accommodating alpha testing while positioning the depth test early in the 3D graphics pipeline. This may be done by dynamically reordering the pipeline depending on whether alpha testing has been enabled, or by deferring writing of the depth test results until the outcome of alpha testing can be established.

The present invention will now be described by way of several preferred but non-limiting embodiments. The 3D graphics pipelines described below are for rendering display pixel data from input primitive object data and may be incorporated in appropriately configured 3D graphics engines.

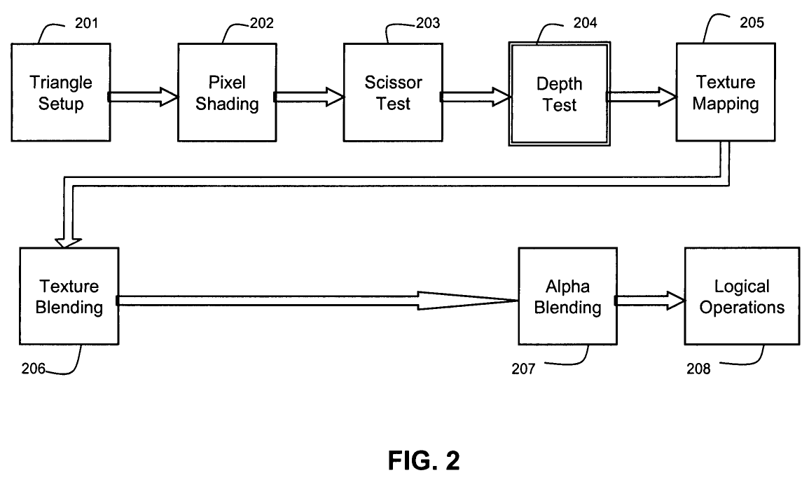

FIG. 2 is a schematic block diagram of a 3D graphics pipeline according to an example of a first embodiment of the present invention. As shown, the pipeline includes a triangle setup stage 201, a pixel shading stage 202, a scissor test stage 203, a depth test stage 204, a texture mapping stage 205, a texture blending stage 206, an alpha blending stage 207, and a logical operations stage 208.

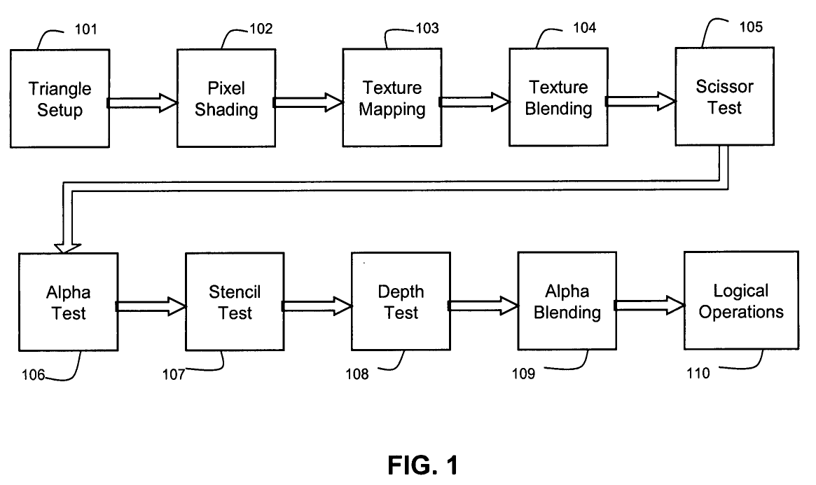

The operations of the respective pipeline stages shown in FIG. 2 may be the same as those described previously in connection with the Open GL configuration of FIG. 1, and accordingly, a detailed description of each stage is omitted here to avoid redundancy. However, as shown in FIG. 2, the depth test stage 204 is placed early in the pipeline, and in particular, before the texture mapping stage 205.

According to the configuration of FIG. 2, depth test is done as early as possible in the pipeline in order to save memory bandwidth and power associated with pixels which ultimately are not being visible. In other words, bandwidth and power are not wasted on pixels which are not finally rendered in the displayed image. This is especially advantageous when processing 3D graphics for display on portable or hand-held devices.

The embodiment of the example of FIG. 2 does not include alpha testing. This is because the alpha testing requires an alpha value for the pixel which can not be computed until after texture blending has occurred, and depth testing of a pixel can not occur until alpha testing has confirmed that the pixel exceeds a transparency threshold. Accordingly, in the example of FIG. 2, the depth test is positioned prior to the texture mapping stage to minimize bandwidth and power consumption, but at the cost of not having an alpha testing stage in the pipeline. The remaining embodiments of the invention are directed to configurations in which alpha testing is accommodated notwithstanding early placement of the depth test stage in the pipeline.

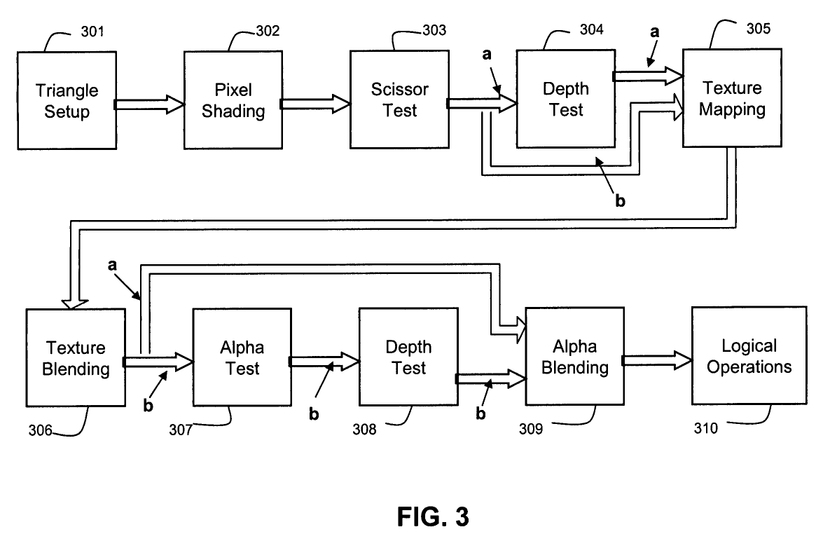

FIG. 3 is a schematic block diagram of a graphics pipeline according to an example of a second embodiment of the present invention. As shown, the pipeline includes a triangle setup stage 301, a pixel shading stage 302, a scissor test stage 303, a first depth test stage 304, a texture mapping stage 305, a texture blending stage 306, an alpha test stage 307, a second depth test stage 308, an alpha blending stage 309, and a logical operations stage 310.

The pixel operations of the respective pipeline stages shown in FIG. 3 may generally be the same as those described previously in connection with the Open GL configuration of FIG. 1, and accordingly, a detailed description of each stage is omitted here to avoid redundancy. However, as shown in FIG. 3, a first depth test stage 304 is placed early in the pipeline, and in particular, before the texture mapping stage 305, and a second depth test stage 308 is located between the alpha test stage 307 and the alpha blending stage 309.

The operational sequence of stages of the pipeline of FIG. 3 is dynamically reordered depending on whether alpha testing is enabled for a pixel being processed. That is, in the case where alpha testing is not enabled, the pipeline progresses as shown by reference “a” of FIG. 3 as follows: triangle setup stage 301→pixel shading stage 302→scissor test stage 303→depth test stage 304→texture mapping stage 305→texture blending stage 306→alpha blending stage 309→logical operations stage 310.

In the case where alpha testing is enabled for a pixel, the stages progress as shown by reference “b” of FIG. 3 as follows: triangle setup stage 301→pixel shading stage 302→scissor test stage 303→texture mapping stage 305→texture blending stage 306→alpha test stage 307→depth test stage 308→alpha blending stage 309→logical operations stage 310.

Generally, a graphics pipeline includes control bits which are shifted down the pipeline together with the pixel data. One of those control bits is the alpha test bit. Also generally, when a batch of triangle is applied to the pipeline, each triangle of the batch will have the same alpha test setting.

Assume that alpha testing is initially disabled, and accordingly, the pipeline of FIG. 3 is arranged according to reference “a” such that first depth test 304 is executed, and such that the alpha test 307 and second depth test 308 are bypassed. Assume further that an alpha test bit is then detected in the pipeline which indicates that the alpha testing is enabled. At that time, a local flush of data is executed from the depth test 304 to the texture blending stage 306, and the first depth test 304 is bypassed, and the alpha test 307 and the second depth 308 are activated (not bypassed). In this manner, the arrangement of reference “b” of FIG. 3 is achieved. Eventually, when the alpha test bit indicates that alpha testing is disabled, the pipeline is reordered back to the arrangement of reference “a”.

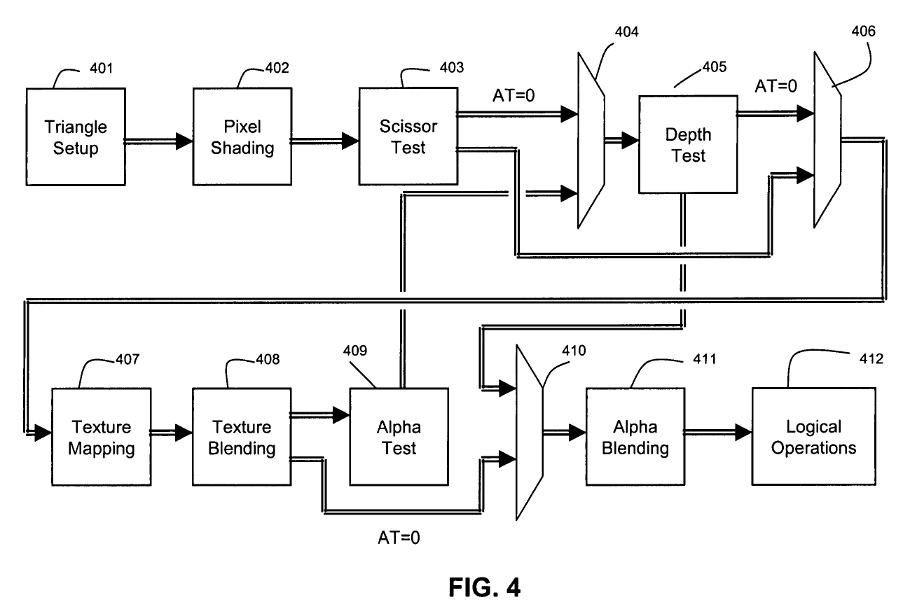

FIG. 4 is a schematic block diagram of a graphics pipeline according to an example of a third embodiment of the present invention. As shown, the pipeline includes a triangle setup stage 401, a pixel shading stage 402, a scissor test stage 403, a first multiplexer 404, a depth test stage 404, a second multiplexer 406, a texture mapping stage 407, a texture blending stage 408, an alpha test stage 409, a third multiplexer 410, an alpha blending stage 411, and a logical operations stage 412.

The pixel operations of the respective pipeline stages shown in FIG. 4 may generally be the same as those described previously in connection with the Open GL configuration of FIG. 1, and accordingly, a detailed description of each stage is omitted here to avoid redundancy. However, as shown in FIG. 4, a depth test stage 405 is placed early in the pipeline, and in particular, before the texture mapping stage 407, and the multiplexers 404, 406 and 410 are adopted to allow for dynamic reordering of the pipeline to accommodate alpha testing when necessary.

The condition “AT=0” of FIG. 4 denotes the state where alpha testing is disabled for the pixels being processed. In that case, multiplexer 404 selects the output from the scissor test stage 403 and applies the same to the depth test stage 405; multiplexer 406 selects the output from the depth test stage 405 and applies the same to the texture mapping stage 407; and multiplexer 410 selects the output from the texture blending stage 408 and applies the same to the alpha blending stage 411. Thus, when AT=0, the pipeline sequence is as follows: triangle setup stage 401→pixel shading stage 402→scissor test stage 403→depth test stage 405→texture mapping stage 407→texture blending stage 408→alpha blending stage 411→logical operations stage 412.

When AT≠0, alpha testing is enabled for the pixels being processed. In that case, multiplexer 404 selects the output from the alpha test stage 409 and applies the same to the depth test stage 405; multiplexer 406 selects the output from the scissor test stage 403 and applies the same to the texture mapping stage 407; and multiplexer 410 selects the output from depth test stage 405 and applies the same to the alpha blending stage 411. Thus, when AT≠0, the pipeline sequence is as follows: triangle setup stage 401→pixel shading stage 402→scissor test stage 403→texture mapping stage 407→texture blending stage 408→alpha test stage 409→depth test stage 405→alpha blending stage 411→logical operations stage 412.

In each of the embodiments of FIGS. 3 and 4, the 3D graphics pipeline is reordered depending on whether alpha testing has been enabled. If alpha testing is enabled, then the depth test stage is functionally located after the alpha test stage since the alpha test results are needed in advance of the depth test. If alpha testing is disabled, then the depth test stage is functionally located before the texture mapping stage to eliminate non-visible pixels early in the pipeline, thus conserving power and bandwidth.

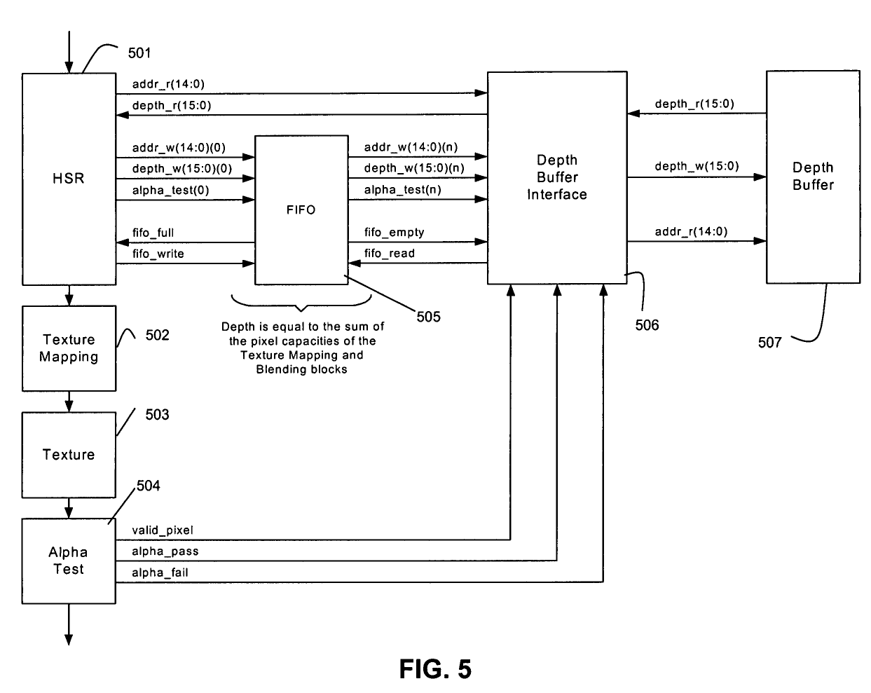

FIG. 5 is a schematic block diagram of an example of another embodiment of the present invention. Like the embodiments of FIGS. 3 and 4, the configuration of FIG. 5 is capable of accommodating alpha testing while at the same time positioning the depth test stage early in the pipeline.

Illustrated in FIG. 5 are a depth test (HSR) stage 501, a texture mapping stage 502, a texturing stage 503, an alpha stage 504, an FIFO circuit 505, a depth buffer interface 506, and a depth buffer 507. The depth test stage 501, the texture mapping stage 502, the texturing stage 503 and the alpha stage 504 form part of the graphics pipeline of a 3D graphics engine.

In operation, a processed pixel arrives via the pipeline to the depth test stage 501, and the z-axis value (depth value) of the pixel is compared with a z-axis value stored in a corresponding location of the depth buffer 507. This is done by transmitting a read address [addr_r(14:0)] to the depth buffer 507 via the buffer interface 506, and receiving a depth buffer z-axis value [depth_r(15:0)] stored in the depth buffer 507. The z-axis value of the pixel and the z-axis value of the depth buffer are compared, and if the comparison result indicates that the pixel would not be visible, the pixel is effectively discard. On the other hand, if the comparison result suggests that the pixel would be visible, a deferred buffer write process is executed as described below.

Assuming the FIFO circuit 505 is not full as indicated by the signal [fifo_full], the deferred buffer write process is carried out by issuing a FIFO write command [fifo_write], and then writing a buffer write address signal [addr_w(14:0)], a new pixel z-axis value [depth_w(15:0)], and an alpha test signal [alpha_test] to the FIFO circuit 505. The buffer write address signal [addr_w(14:0)] is indicative of the corresponding location of the depth buffer 507 of the processed pixel. The new pixel z-axis value [depth_w(15:0)] is the z-axis value of the processed pixel (which has passed the depth test). The alpha test signal [alpha_test] indicates whether alpha testing has been enabled for the processed pixel.

As the buffer write address signal [addr_w(14:0)], the new pixel z-axis value [depth_w(15:0)], and the alpha test signal [alpha_test] are shifted through the FIFO circuit 505, the processed pixel is simultaneously subjected to texture mapping and texturing by the texturing mapping stage 502 and the texturing stage 503, respectively. The depth “n” of the FIFO circuit 505 is preferably equal to the sum of the pixel capacities of the pipeline stages interposed between the depth test stage 501 and the alpha test stage 504. In this embodiment, the depth of the FIFO circuit 505 is equal to the sum of the pixel capacities of the texture mapping stage 502 and the texturing stage 503. As a result, a pixel will have worked its way to the end of the FIFO circuit 505 at a timing which is coincident with the processing of the pixel by the texture mapping stage 502 and the texturing stage 503.

After texture mapping and texturing, the processed pixel is then applied to the alpha test stage 504. At this time, the pixel is either alpha test enabled or not alpha test enabled.

If the pixel is not alpha test enabled, the pixel is transmitted down the pipeline for further processing, and a [valid_pixel] signal is transmitted to the depth buffer interface 506. Assuming the FIFO circuit 505 is not empty as indicated by the signal [fifo_empty], the depth buffer interface is responsive to the [valid_pixel] signal to issue a read command [fifo_read] to the FIFO circuit 505, and to read the buffer write address signal [addr_w(14:0)], the new pixel z-axis value [depth_w(15:0)], and the alpha test signal [alpha_test]. The depth buffer interface 506 then updates the depth buffer 507 by addressing the depth buffer 507 at the address [addr_w(14:0)], and overwriting the new pixel z-axis value [depth_w(15:0)] into the depth buffer 507.

If the pixel is alpha test enabled, the alpha test stage 504 compares the alpha value of the process pixel with a reference value. If the pixel passes the alpha test, the [alpha_pass] signal is transmitted to the depth buffer interface 506, and the pixel is transmitted down the pipeline for further processing. If the pixel fails the alpha test, the [alpha_fail] signal is transmitted to the depth buffer interface 506, and the pixel is effectively discarded.

Again, assuming the FIFO circuit 505 is not empty as indicated by the signal [fifo_empty], the depth buffer interface is responsive to the [alpha_pass] and [alpha_fail] signals to issue a read command [fifo_read] to the FIFO circuit 505, and to read the buffer write address signal [addr_w(14:0)], the new pixel z-axis value [depth_w(15:0)], and the alpha enable signal [alpha_test]. If the [alpha_fail] signal is active, the depth buffer interface 506 does not update the depth buffer 507 with the new pixel z-axis value [depth_w(15:0)]. On the other hand, if the [alpha_pass] signal is active, the depth buffer interface 506 updates the depth buffer 507. That is, the depth buffer interface addresses the depth buffer 507 at the address [addr_w(14:0)], and overwrites the new pixel z-axis value [depth_w(15:0)] into the depth buffer 507.

The implementation described above in connection with FIG. 5 includes a circuit (e.g., a FIFO circuit) which temporarily stores the results of the depth test. Actual writing of the new z-axis value into the depth buffer is deferred until the results of the alpha test associated with the new pixel are available. If alpha test passes, the new z-axis value of the new pixel is stored in the depth buffer. If alpha test fails, it is not. If there is no alpha test, the new z-axis value can be written immediately, but only after any z-axis values that have a pending alpha test are written. The [alpha_test] signal can be used for this purpose. That is, if all pending z-axis value results show no alpha testing, the depth buffer interface can be configured to immediately read the FIFO circuit 505 and update the depth buffer 507 accordingly.

By deferring the updating of the depth buffer pending the outcome of alpha testing as in the embodiment of FIG. 5, the depth test stage may be located early in the pipeline to avoid later processing of non-visible pixels, thus conserving power and bandwidth.

In the drawings and specification, there have been disclosed typical preferred embodiments of this invention and, although specific examples are set forth, they are used in a generic and descriptive sense only and not for purposes of limitation. It should therefore be understood the scope of the present invention is to be construed by the appended claims, and not by the exemplary embodiments.

1. A graphics pipeline for processing pixel data and comprising a plurality of sequentially arranged processing stages which render display pixel data from input primitive object data, wherein said processing stages include at least a texturing stage and a depth test stage, and wherein said depth test stage is located earlier in the graphics pipeline than said texturing stage.

2. The graphics pipeline of claim 1, wherein the plurality of sequentially arranged processing stages further includes a scissor test stage, and wherein the depth test stage is functionally located between the scissor test stage and the texturing stage.

3. The graphics pipeline of claim 1, wherein the texturing stage includes a texture mapping stage and a texture blending stage.

4. The graphics pipeline of claim 1, wherein the plurality of sequentially arranged processing stages is devoid of an alpha test stage.

5. The graphic pipeline of claim 1, wherein the plurality of sequentially arranged processing stages includes an alpha test stage.

6. The graphics pipeline of claim 5, further comprising a depth buffer which stores depth values obtained by the depth test stage, wherein the alpha test stage is located after the texturing stage, and wherein storing of the depth values into the depth buffer is temporarily deferred under control of the alpha test stage.

7. The graphics pipeline of claim 5, wherein said pipeline is dynamically reordered between at least first and second stage sequences responsive to a disabled alpha test state and an enabled alpha test state, respectively, of processed pixel data,
wherein, in said first stage sequence, said depth test stage is functionally located earlier in the graphics pipeline than said texturing stage, and
wherein, in said second stage sequence, said depth test stage is functionally located later in the graphics pipeline than said texturing stage and said alpha test stage.

8. A graphics pipeline for processing pixel data, comprising:
a plurality of sequentially arranged processing stages which render display data from input primitive object data, wherein said processing stages include at least a texturing stage, an alpha test stage and a depth test stage;
wherein said pipeline is dynamically reordered between at least first and second stage sequences according to an alpha test state of processed pixel data,
wherein, in said first stage sequence, said depth test stage is functionally located earlier in the graphics pipeline than said texturing stage, and
wherein, in said second stage sequence, said depth test stage is functionally located after said texturing stage and said alpha test stage.

9. The graphics pipeline of claim 8, further comprising a plurality of multiplexers operatively coupled between processing stages of the pipeline and controlled according to the alpha test state of the processed pixel data.

10. The graphics pipeline of claim 9, wherein the plurality of multiplexers comprises:
a first multiplexer which applies an output from a previous pipeline stage to the depth test stage when the alpha test state is disabled, and which applies an output from the alpha test stage to the depth test stage when the alpha test state is enabled;
a second multiplexer which applies an output from the depth test stage to the texturing stage when the alpha test state is disabled, and which applies an output from the previous pipeline stage to the texturing stage when the alpha test state is enabled; and
a third multiplexer which applies an output from texturing stage to a subsequent stage when the alpha test state is disabled, and which applies an output from the depth test stage to the subsequent stage when the alpha test state is enabled.

11. The graphics pipeline of claim 10, wherein the previous stage is a scissor test stage.

12. The graphics pipeline of claim 11, wherein the subsequent stage is an alpha blending stage.

13. The graphics pipeline of claim 8, wherein the texturing stage comprises a texture mapping stage and a texture blending stage.

14. The graphics pipeline of claim 8, wherein pixel data of at least one stage of the graphics pipeline is flushed when transitioning between the first and second stage sequences.

15. A graphics pipeline for processing pixel data, comprising:
a depth buffer which stores depth values;
a depth test stage which compares a current depth value of a processed pixel with a previous depth value stored in the depth buffer, and which issues a write command to overwrite the previous depth value with the current depth value based on a comparison result;
write defer circuitry which temporarily defers execution of the write command issued by depth test stage;
a texturing stage which receives the processed pixel after the depth test stage; and
an alpha test stage which receives the processed pixel after the texturing stage;
wherein the write defer circuitry is responsive to the alpha test stage to either disregard or execute the deferred write command issued by the depth test stage.

16. The graphics pipeline of claim 15, wherein the write defer circuitry comprising a FIFO circuit which receives the current depth value from the depth test stage, and an interface circuit operatively coupled between the FIFO circuit and the depth buffer.

17. The graphics pipeline of claim 16, wherein the depth of the FIFO circuit is equal to the sum of the pixel capacities of the texturing stage.

18. The graphics pipeline of claim 17, wherein the texturing stage comprises a texture mapping stage and a texture blending stage.

19. The graphics pipeline of claim 17, wherein the alpha test stage transmits a first signal to the depth buffer interface when a processed pixel passes an alpha test, and a second signal to the depth buffer interface when the processed pixel fails the alpha test, and wherein the depth buffer interface is responsive to the first signal to execute the deferred write command, and wherein the depth buffer interface is responsive to the second signal to disregard the deferred write command.

20. The graphics pipeline of claim 17, wherein the alpha test stage transmits a third signal when a processed pixel functionally bypasses the alpha test stage, and wherein the depth buffer interface is responsive to the third signal to execute the deferred write command.

21. A graphics pipeline for processing pixel data, comprising:
a plurality of sequentially arranged processing stages which render display data from input primitive object data, wherein said processing stages include at least a texturing stage, an alpha test stage and a depth test stage; and
means responsive to an alpha test state of processed pixel data for dynamically reordering the sequential arrangement of the processing stages between at least first and second stage sequences, wherein, in said first stage sequence, said depth test stage is functionally located earlier in the graphics pipeline than said texturing stage, and wherein, in said second stage sequence, said depth test stage is functionally located after said texturing stage and said alpha test stage.

22. The graphics pipeline of claim 21, wherein the texturing stage comprises a texture mapping stage and a texture blending stage.

23. The graphics pipeline of claim 21, wherein pixel data of at least one stage of the graphics pipeline is flushed when said means transitions between the first and second stage sequences.

24. A graphics pipeline for processing pixel data, comprising:
a depth buffer which stores depth values;
a depth test stage which compares a current depth value of a processed pixel with a previous depth value stored in the depth buffer, and which issues a write command to overwrite the previous depth value with the current depth value based on a comparison result;
a texturing stage which receives the processed pixel after the depth test stage;
an alpha test stage which receives the processed pixel after the texturing stage; and
write defer means for deferring execution of the write command issued by depth test stage under control of the alpha test stage.

25. The graphics pipeline of claim 24, wherein the texturing stage comprises a texture mapping stage and a texture blending stage.

26. A method for processing pixel data, comprising:
executing a depth test pipeline stage which includes comparing a current depth value of a processed pixel with a previous depth value stored in a memory, discarding the processed pixel when the comparison indicates that the processed pixel is not a visible pixel, and storing the current depth value when the comparison indicates that the processed pixel is a visible pixel; and
executing a texturing pipeline stage, after said depth test pipeline stage, which includes applying texture parameters to a processed pixel which has not been discarded during execution of the depth test process.

27. The method of claim 26, further comprising executing an alpha test pipeline stage, after said texturing pipeline stage, which includes comparing a current alpha value of a processed pixel with a reference alpha value, wherein said storing of the current depth value of the processed pixel by said depth test pipeline stage is deferred pending execution of said alpha test pipeline stage.

28. A method for processing pixel data, comprising:
executing a depth test pipeline stage which includes comparing a current depth value of a processed pixel with a previous depth value stored in a memory, discarding the processed pixel when the comparison indicates that the processed pixel is not a visible pixel, and storing the current depth value when the comparison indicates that the processed pixel is a visible pixel;
executing a texturing pipeline stage which includes applying texture parameters to a processed pixel; and
dynamically reordering a pipeline sequence between at least first and second pipeline sequences,
wherein, in said first pipeline sequence, said depth test pipeline stage is executed prior to said texturing pipeline stage, and
wherein, in said second pipeline sequence, said depth test pipeline stage is executed after said texturing stage.

29. The method of claim 28, wherein said second pipeline sequence further includes an alpha test pipeline which is executed after said texturing stage.

30. The method of claim 29, wherein said first pipeline sequence is executed when a processed pixel is not alpha test enabled, and wherein said second pipeline sequence is executed when the processed pixel is alpha test enabled.

31. A method for processing pixel data, comprising:
comparing a current depth value of a processed pixel with a previous depth value stored in a memory, discarding the processed pixel when the comparison indicates that the processed pixel is not a visible pixel, and applying texture parameters to the processed pixel when the comparison indicates that the processed pixel is a visible pixel;
comparing an alpha value of the processed pixel having the texture parameters with a reference alpha value, discarding the process pixel when the alpha value of the processed pixel is less than the reference alpha value, and storing the current depth value of the processed pixel in the memory when the alpha value of the processed pixel is greater than the reference alpha.

32. The method of claim 31, comprising temporarily storing the current depth value of the processed pixel in a second memory pending a result of the comparison between the alpha value of the processed pixel and the reference alpha value.

33. The method of claim 32, wherein the second memory is a FIFO circuit.
